(19) United States
(12) Patent Application Publication
(10) Pub. No.: US 2019/0358889 A1
(43) Pub. Date: Nov. 28, 2019

(54) COOLER BOX MANUFACTURING METHOD

(71) Applicant: FTI GROUP (HOLDING) COMPANY LIMITED, Grand Cayman (KY)

(72) Inventor: Jerry MOON, Taipei (TW)

(73) Assignee: FTI GROUP (HOLDING) COMPANY LIMITED, Grand Cayman (KY)

(21) Appl. No.: 15/988,938

(22) Filed: May 24, 2018

(51) Int. Cl. B29C 51/10; B29B 11/10; B29C 65/02; B29C 53/02; B29C 51/00

(52) U.S. Cl. CPC B29C 51/10; B29B 11/10; B29K 2055/02; B29C 53/02; B29C 51/002; B29C 65/02

(57) ABSTRACT

A cooler box manufacturing method includes the steps of bonding an acrylonitrile butadiene styrene (ABS) sheet material to a polycarbonate (PC) layer to form a two-layered panel; heating and softening the two-layered panel and attaching the latter to a forming mold by vacuum suction to provide a rigid body shell and a rigid cover shell; sequentially attaching insulation pads and inner wall layers to inner surfaces of the rigid body and cover shells to provide a cooler box body and a cooler box cover that respectively internally have insulation pad or pads covered by an inner wall layer; and finally, pivotally connecting the cooler box cover to the cooler box body to complete a cooler box. The cooler box so manufactured has rigid shells to not only provide heat and cool insulation for food and beverage storage, but also prevent the stored food and beverage from colliding with one another.

### FIELD OF THE INVENTION

The present invention relates to a cooler box manufacturing method, and more particularly, to a manufacturing method that uses specific material and steps to manufacture a cooler box.

### BACKGROUND OF THE INVENTION

Many people are interested in fishing and camping. Generally, a fishing lover or a camping lover would carry a cooler box along with him or her for storing fish caught or food and/or beverage. Most of the currently available cooler boxes are manufactured using an injection molding machine, with which a polypropylene (PP) material is injected and molded to form a product with a required configuration. The PP molded cooler box is not shatterproof and not collision-resistant. When the PP cooler box is subjected to a forceful collision, it is easily broken and damaged. In a worse condition, the cooler box is no longer usable and must be repaired, or a new cooler box must be purchased to replace the damaged one.

### SUMMARY OF THE INVENTION

A primary object of the present invention is to provide a cooler box manufacturing method, with which a cooler box having rigid shells can be manufactured to not only provide heat and cold insulation for food and beverage storage, but also prevent the stored food and beverage from colliding with one another in the cooler box.

To achieve the above and other objects, the cooler box manufacturing method according to a preferred embodiment of the present invention includes a sheet material processing step, an inner wall layer forming step, a shell forming step, an interior processing step, and a connecting step.

In the sheet material processing step, a quantity of acrylonitrile butadiene styrene (ABS) granules is provided, heated and softened to form a half-solid viscous ABS material; the viscous ABS material is extruded through a mold opening to form an ABS sheet material; and the ABS sheet material is bonded to a polycarbonate (PC) layer to form a two-layered panel. In the preferred embodiment, the ABS granules are heated and softened in a processing environment of 200 to 230° C.

In the inner wall layer forming step, a waterproof sheet material is cut to provide a bottom piece, a sidewall piece and an annular piece; the sidewall piece is curled and vertically positioned on an outer peripheral edge of the bottom piece; the curled sidewall piece is connected to the bottom piece by thermal pressing; and finally, the annular piece is horizontally positioned on along an upper end of the curled sidewall piece and connected thereto by thermal pressing to complete an inner wall layer. In the preferred embodiment, the thermal pressing is performed at a temperature of 50° C.

In the shell forming step, the two-layered panel is heated and softened to form a softened two-layered panel, which is deformable; and the softened two-layered panel is attached to an outer surface of a forming mold by applying a vacuum suction operation to the softened two-layered panel, so that a rigid body shell and a rigid cover shell are formed. In the preferred embodiment, the two-layered panel is heated and softened in a processing environment of 150-200° C.

In the interior processing step, insulation pads are attached to inner surfaces of the rigid body shell and the rigid cover shell, and the inner wall layer is covered onto the insulation pads in each of the rigid body and cover shells, so as to provide a cooler box body and a cooler box cover. Finally, in the connecting step, the cooler box cover is pivotally connected to the cooler box body to complete a cooler box.

The cooler box manufacturing method according to the present invention is characterized in sequentially attaching the insulation pads and the inner wall layers to the inner surfaces of the rigid body shell and the rigid cover shell to provide the cooler box body and the cooler box cover, and then pivotally connecting the cooler box cover to the cooler box body to complete the cooler box. The cooler box so manufactured externally includes a rigid body shell and a rigid cover shell and internally includes soft insulation pads and inner wall layers, and accordingly, can provide heat and cold insulation for food and beverage storage as well as prevent the stored food and beverage from colliding with one another in the cooler box.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a flowchart showing the steps included in a cooler box manufacturing method according to a first preferred embodiment of the present invention;

FIGS. 2A and 2B are pictorial descriptions of a sheet material processing step included in the method according to the first preferred embodiment of the present invention;

FIG. 3 is a pictorial description of an inner wall layer forming step included in the method according to the first preferred embodiment of the present invention;

FIGS. 4A and 4B are pictorial descriptions of a first shell forming step included in the method according to the first preferred embodiment of the present invention;

FIG. 5 is a pictorial description of a first interior processing step included in the method according to the first preferred embodiment of the present invention;

FIGS. 6A and 6B are pictorial descriptions of a second shell forming step included in the method according to the first preferred embodiment of the present invention;

FIG. 7 is a pictorial description of a second interior processing step included in the method according to the first preferred embodiment of the present invention;

FIG. 8 is a pictorial description of a connecting step included in the method according to the first preferred embodiment of the present invention; and

FIGS. 9A and 9B are pictorial descriptions of a sheet material processing step included in the method according to a second preferred embodiment of the present invention.

### DETAILED DESCRIPTION OF THE PREFERRED EMBODIMENTS

The present invention will now be described with some preferred embodiments thereof and by referring to the accompanying drawings.

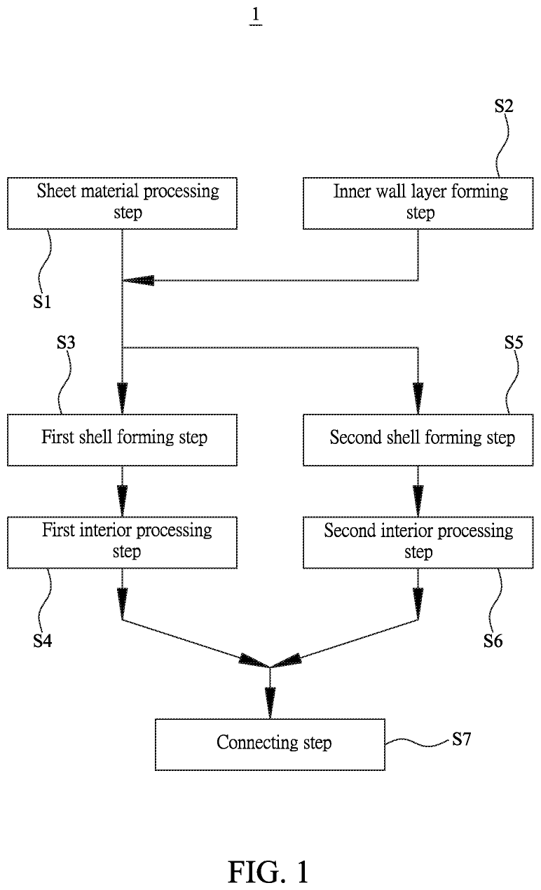

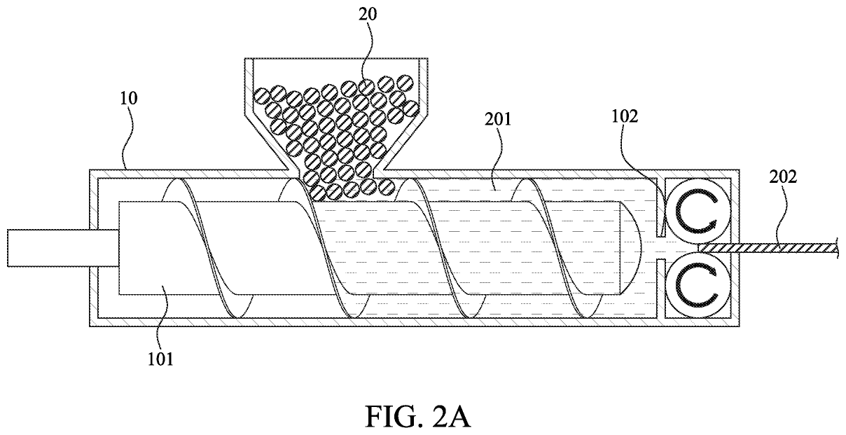

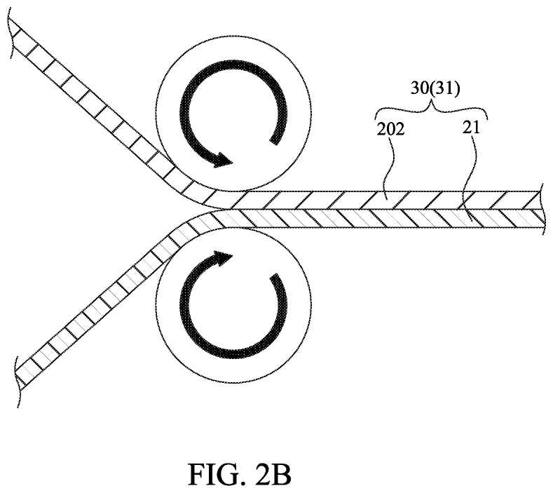

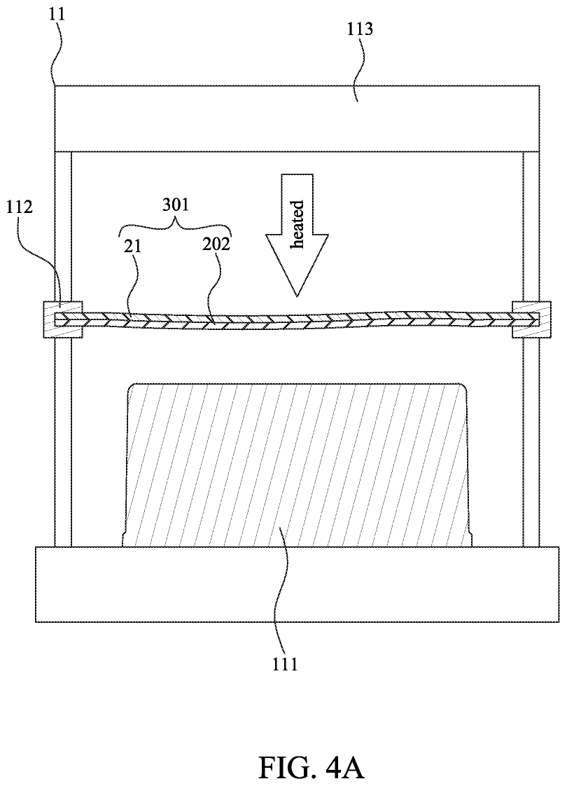

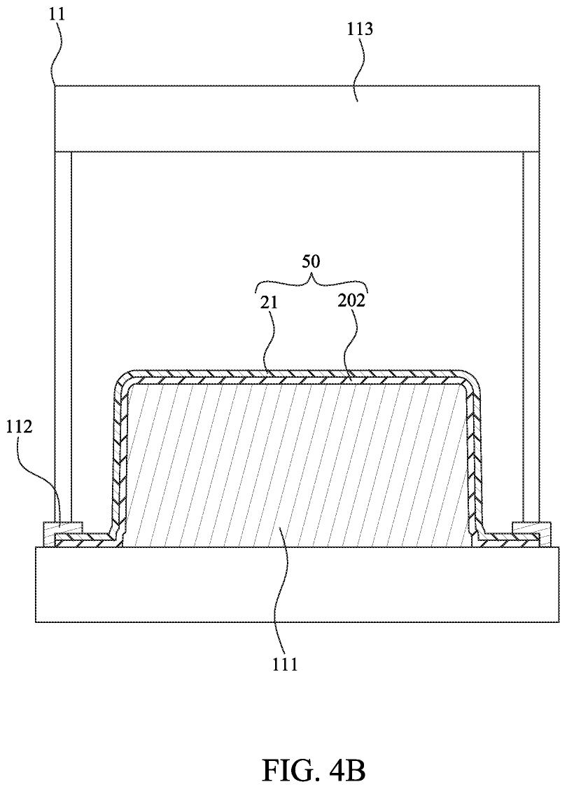

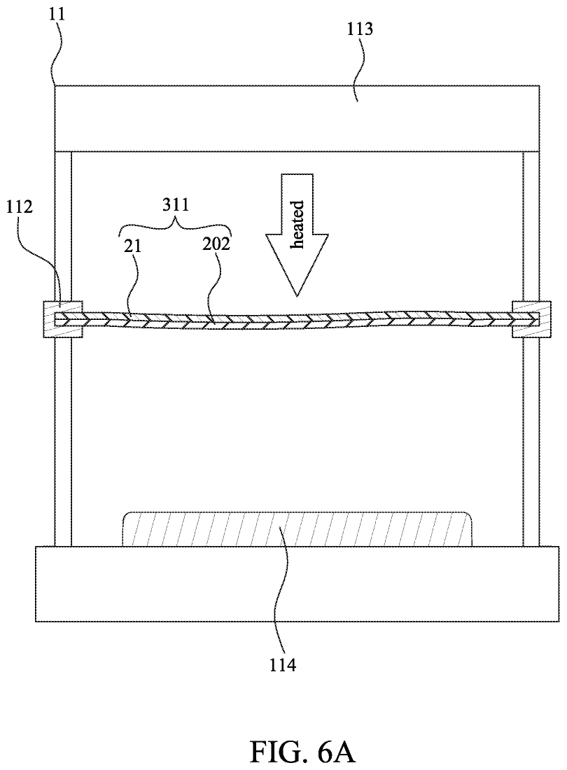

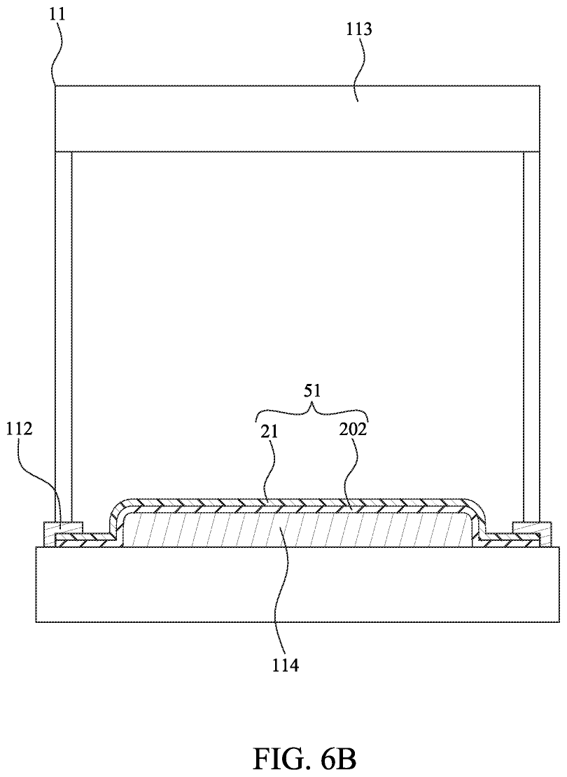

Please refer to FIG. 1 along with FIGS. 2A and 2B. A cooler box manufacturing method 1 according to a first preferred embodiment of the present invention is implemented using a sheet making machine 10, a high-frequency machine (not shown) and a vacuum forming machine 11 (see FIGS. 4A, 4B, 6A and 6B). Firstly, in a sheet material processing step S1 of the method 1, the sheet making machine 10 is heated to gradually raise the temperature of a screw 101 provided therein to a range of 200 to 230° C. Then, a quantity of acrylonitrile butadiene styrene (ABS) granules 20 is put into the sheet making machine 10 and the screw 101 is actuated to rotate, so that the ABS granules 20 are conveyed by the rotating screw 101 toward a die opening 102 formed on the sheet making machine 10. The ABS granules 20 are heated and softened in the high-temperature processing environment of 200 to 230° C. when they are conveyed through the screw 101 and accordingly, together form a half-solid viscous ABS material 201. The viscous ABS material 201 flows to the die opening 102 and is extruded therethrough to form an ABS sheet material 202. Then, the ABS sheet material 202 is tightly bonded to a colored or patterned polycarbonate (PC) layer 21, and the bonded ABS sheet material 202 and PC layer 21 are cut to provide a first two-layered panel 30 and a second two-layered panel 31. Therefore, the first and the second two-layered panel 30, 31 respectively consist of the ABS sheet material 202 and the PC layer 21. However, the forming of the first and the second two-layered panels 30, 31 using the ABS sheet material 202 and the PC layer 21 is only illustrative to facilitate easy description of the present invention. In other operable embodiments of the present invention, the first and second two-layered panels 30, 31 are not necessarily formed of bonded ABS sheet material 202 and PC layer 21, but can be formed of, for example, an ABS sheet material 202 and a colored and patterned ABS layer that are bonded together.

In the first preferred embodiment, since the ABS granules 20 is heated and softened in the processing environment of 200-230° C., they won't become charred due to an excessively high processing temperature and the viscous ABS material 201 so formed is indirectly prevented from losing its plasticity and resilience; meanwhile, the ABS granules 20 also won't fail to form the half-solid viscous ABS material 201 due to an excessively low processing temperature and the subsequent forming of the ABS sheet material 202 won't be indirectly hindered. In other words, when the screw 101 is heated to a temperature over 230° C., the ABS granules 20 will be charred and the produced viscous ABS material 201 will lose its plasticity and resilience; and when the screw 101 is only heated to a temperature lower than 200° C., the ABS granules 20 won't be able to form the viscous ABS material 201.

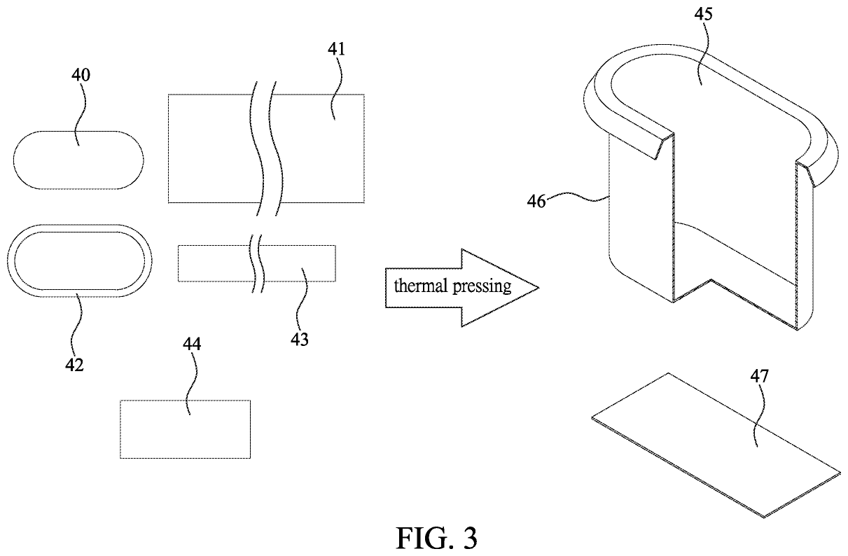

Please refer to FIG. 1 along with FIG. 3. An inner wall layer forming step S2 can be synchronously performed when the sheet material processing step S1 is performed. Firstly, in the step S2, a waterproof sheet material (not shown) is cut to provide several differently shaped and sized pieces, including a bottom piece 40, a sidewall piece 41, an annular piece 42, a connecting piece 43 and a covering piece 44. Then, the high-frequency machine is electrically connected to an external power supply and electrically heated to a temperature of 50° C. Then, the sidewall piece 41 is curled into a substantially oblong member, which is vertically positioned over an outer peripheral edge of the bottom piece 40. Thereafter, the sidewall piece 41 in the form of an oblong member is vertically thermally pressed against the outer peripheral edge of the bottom piece 40 using the high-frequency machine at the temperature of 50° C., so that a receiving space 45 is formed in between the bottom piece 40 and the curled sidewall piece 41. Then, the annular piece 42 and the connecting piece 43 are also thermally pressed at the temperature of 50° C. against an upper end of the vertical sidewall piece 41 opposite to the bottom piece 40 to thereby form a three-dimensional first inner wall layer 46. In FIG. 3, the annular piece 42 is horizontally located between the sidewall piece 41 and the connecting piece 43 to be flush with the upper end of the sidewall piece 41. Further, the covering piece 44 alone forms a flat second inner wall layer 47. Therefore, the second inner wall layer 47 has a shape different from that of the first inner wall layer 46.

Please refer to FIG. 1 along with FIGS. 4A and 4B. After the steps S1 and S2, a first shell forming step S3 is performed. In the step S3, a first forming mold 111 is mounted in the vacuum forming machine 11, and the first two-layered panel 30 is connected to a supporting frame 112 provided in the vacuum forming machine 11. Then, a heating mechanism 113 mounted in the vacuum forming machine 11 starts heating, so that the first two-layered panel 30 is heated and softened in a heating environment of 150-200° C. to form a first softened two-layered panel 301, which is deformable. Then, the supporting frame 112 is moved toward the first forming mold 111 and the vacuum forming machine 11 is actuated to perform a vacuum suction operation, which is applied to the first softened two-layered panel 301, so that the first softened two-layered panel 301 is attached to an outer surface of the first forming mold 111 under a vacuum suction force and forms a three-dimensional rigid body shell 50. In the first preferred embodiment, the rigid body shell 50 is milled after it is cooled in order to remove burrs from the rigid body shell 50. On the finished rigid body shell 50, the PC layer 21 and the ABS sheet material 202 are located at an outermost and an innermost side, respectively, of the rigid body shell 50, so that the colors and patterns provided on the PC layer 21 are visible on the outer surface of the rigid body shell 50.

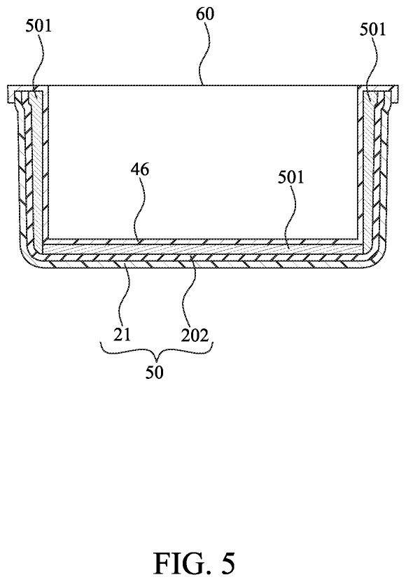

Please refer to FIG. 1 along with FIG. 5. After the step S3, a first interior processing step S4 is performed. In the step S4, a plurality of soft first insulation pads 501 is attached to inner surfaces of the rigid body shell 50. In the illustrated first preferred embodiment, a first piece of the first insulation pads 501 is attached to an inner bottom surface of the rigid body shell 50 while other pieces of the first insulation pads 501 are attached to inner front, rear, left and right surfaces of the rigid body shell 50. Then, the first inner wall layer 46 is placed over the first insulation pads 501 and connected to the rigid body shell 50 to provide a cooler box body 60 for a cooler box according to the present invention. In the illustrated first preferred embodiment, the bottom piece 40 of the first inner wall layer 46 covers the first piece of the first insulation pads 501, while the sidewall piece 41 of the first inner wall layer 46 covers all other pieces of the first insulation pads 501. Further, the first insulation pads 501 have a hardness value smaller than that of the rigid body shell 50.

Please refer to FIG. 1 along with FIGS. 6A and 6B. After completion of the sheet material processing step S1, in addition to the first shell forming Step S3, a second shell forming step S5 must also be performed. In the step S5, a second forming mold 114, which is different from the first forming mold 111 in shape, is mounted in the vacuum forming machine 11, and the second two-layered panel 31 is connected to the supporting frame 112 in the vacuum forming machine 11. Then, the heating mechanism 113 mounted in the vacuum forming machine 11 starts heating to a temperature between 150-200° C. to heat the second two-layered panel 31, so that the second two-layered panel 31 forms a second softened two-layered panel 311, which is deformable. Then, the supporting frame 112 is moved toward the second forming mold 114 and the vacuum forming machine 11 is actuated to perform a vacuum suction operation, which is applied to the second softened two-layered panel 311, so that the second softened two-layered panel 311 is attached to an outer surface of the second forming mold 114 under a vacuum suction force and forms a three-dimensional rigid cover shell 51. In the first preferred embodiment, the rigid cover shell 51 is milled after it is cooled in order to remove burrs from the rigid cover shell 51. On the finished rigid cover shell 51, the PC layer 21 and the ABS sheet material 202 are located at an outermost and an innermost side, respectively, of the rigid cover shell 51, so that the colors and patterns provided on the PC layer 21 are visible on the outer surface of the rigid cover shell 51.

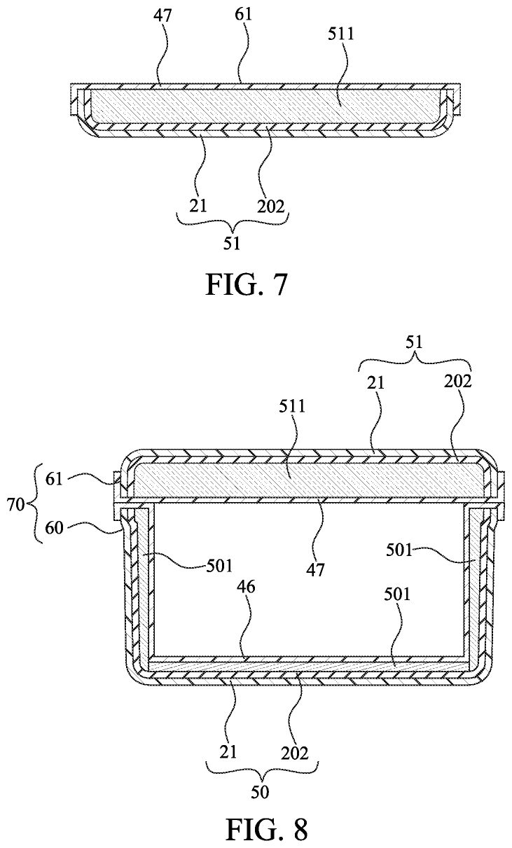

Please refer to FIG. 1 along with FIG. 7. Following the step S5, a second interior processing step S6 is performed. In the step S6, a second insulation pad 511 similar to the first insulation pads 501 in property is prepared and attached to an interior space of the rigid cover shell 51, and the second inner wall layer 47 is connected to the rigid cover shell 51 to cover the second insulation pad 511. Therefore, the second insulation pad 511 is located between the rigid cover shell 51 and the second inner wall layer 47. The second inner wall layer 47, the second insulation pad 511 and the rigid cover shell 51 together provide a cooler box cover 61.

Please refer to FIG. 1 along with FIG. 8. Finally, a connecting step S7 is performed. In the step S7, the cooler box cover 61 is pivotally connected to the cooler box body 60 to complete a cooler box 70. The cooler box cover 61 is pivotally connected to the cooler box body 60, such that the cooler box cover 61 can be pivotally lifted relative to the cooler box body 60. Since the cooler box 70 has a rigid outer side formed of the rigid body shell 50 and the rigid cover shell 51, and a soft inner side formed of the first insulation pads 501 and the first inner wall layer 46 as well as the second insulation pad 511 and the second inner wall layer 47, the cooler box 70 is not only cold-insulating and heat-insulating to ensure good food and beverage storage, but also collision-resistant and shatterproof. Therefore, with the cooler box manufactured using the method of the present invention, it is also able to prevent the stored food and/or beverage from undesirably colliding with one another inside the cooler box 70.

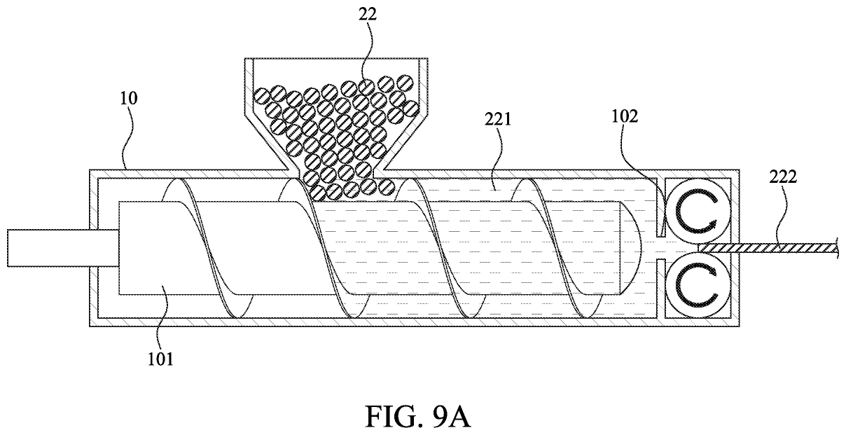

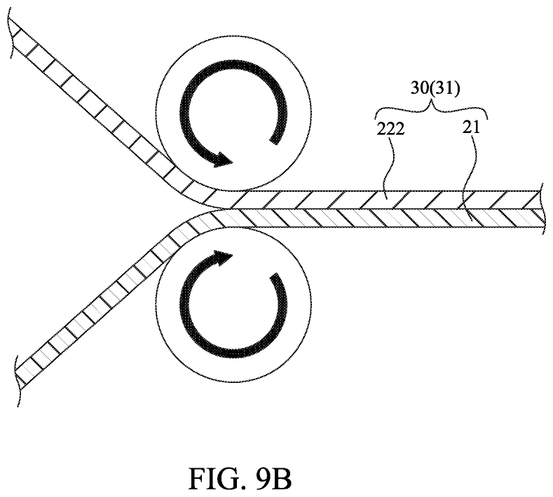

FIGS. 9A and 9B are pictorial descriptions of a sheet material processing step included in the cooler box manufacturing method according to a second preferred embodiment of the present invention. Please refer to FIG. 1 along with FIGS. 9A and 9B. The second preferred embodiment is different from the first one only in the sheet material processing step S1. Therefore, only the step S1 of the second preferred embodiment is described herein while all other similar steps are not repeatedly described.

As shown, to perform the sheet material processing step S1 according to the second preferred embodiment of the present invention, first heat the sheet making machine 10, so that the screw 101 of the sheet making machine 10 is heated to a temperature of 200 to 230° C. Then, put a quantity of polycarbonate (PC) granules 22 into the sheet making machine 10, so that the PC granules 22 are conveyed by the rotating screw 101 toward a die opening 102 formed on the sheet making machine 10. The PC granules 22 are heated and softened in a processing environment of 200 to 230° C. when they are conveyed through the screw 101 and accordingly, together form a half-solid viscous PC material 221. The viscous PC material 221 flows to the die opening 102 and is extruded therethrough to form a PC sheet material 222. Then, the PC sheet material 222 is tightly bonded to a polycarbonate (PC) layer 21, and the bonded PC sheet material 222 and PC layer 21 are cut to provide a first two-layered panel 30 and a second two-layered panel 31. Therefore, the first and the second two-layered panel 30, 31 respectively consist of the PC sheet material 222 and the PC layer 21. However, the forming of the first and the second two-layered panels 30, 31 using the PC sheet material 222 and the PC layer 21 is only illustrative to facilitate easy description of the present invention. In other operable embodiments of the present invention, the first and second two-layered panels 30, 31 are not necessarily formed of bonded PC sheet material 222 and PC layer 21, but can be formed of, for example, a PC sheet material 222 and a colored and patterned ABS layer that are bonded together.

In the second preferred embodiment, the subsequent first shell forming step S3 and second shell forming step S5 are performed by applying the vacuum suction operation to the first and the second two-layer panel 30, 31 that are formed in the sheet material processing step S1 and consist of the PC sheet material 222 and the PC layer 21, so as to form the rigid body shell 50 and the rigid cover shell 51.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A cooler box manufacturing method, comprising:
a sheet material processing step, in which an acrylonitrile butadiene styrene (ABS) sheet material is bonded to a polycarbonate (PC) layer to form a two-layered panel;
a shell forming step, in which the two-layered panel formed in the sheet material processing step is heated to form a softened two-layered panel, which is deformable, and a vacuum suction operation is applied to the soften two-layered panel, so that the softened two-layered panel is sucked and attached to an outer surface of a forming mold to provide a three-dimensional rigid body shell; and the shell forming step being similarly performable using another forming mode to provide a three-dimensional rigid cover shell;
an interior processing step, in which insulation pads are attached to inner surfaces of the rigid body shell and the rigid cover shell, and two inner wall layers are separately connected to the rigid body shell and the rigid cover shell to cover the insulation pads, so that the rigid body shell and the rigid cover shell with the insulation pads and the inner layers form a cooler box body and a cooler box cover, respectively; and
a connecting step, in which the cooler box cover is pivotally connected to the cooler box body to complete a cooler box.

2. The cooler box manufacturing method as claimed in claim 1, wherein, in the sheet material processing step, a quantity of resin granules consisting of ABS granules is provided, heated and softened to form a half-solid viscous ABS material, which is subjected to an extrusion process to form the ABS sheet material.

3. The cooler box manufacturing method as claimed in claim 2, wherein the resin granules are heated and softened in a processing environment of 200 to 230° C.

4. The cooler box manufacturing method as claimed in claim 2, wherein, in the shell forming step, the two-layered panel is heated and softened in a processing environment of 150 to 200° C.

5. The cooler box manufacturing method as claimed in claim 1, further comprising an inner wall layer forming step after the sheet material processing step, and the inner wall layer forming step further including the steps of:
cutting a waterproof sheet material to provide at least a bottom piece, a sidewall piece and an annular piece
curling the sidewall piece and positioning the curled sidewall piece over an outer peripheral edge of the bottom piece, and connecting the curled sidewall piece to the bottom piece by way of thermal pressing; and
horizontally positioning the annular piece on along an upper end of the curled sidewall piece, and connecting the annular piece to the curled sidewall piece by way of thermal pressing to provide the inner wall layer used in the interior processing step; and one inner wall layer being able formed for each of the rigid body shell and the rigid cover shell.

6. The cooler box manufacturing method as claimed in claim 5, wherein the thermal pressing is performed at a temperature of 50° C.
